(19) United States
(12) Patent Application Publication
(10) Pub. No.: US 2003/0066186 A1
(43) Pub. Date: Apr. 10, 2003

(54) Co-axial terminator press fitting pliers

(75) Inventor: Po-Hao Lu, Tu Cheng City (TW)

Correspondence Address: BACON & THOMAS, PLLC, 625 SLATERS LANE, FOURTH FLOOR, ALEXANDRIA, VA, 22314

(73) Assignee: HANLONG IND. CO., LTD., Taipei Hsien (TW)

(21) Appl. No.: 09/969,664

(22) Filed: Oct. 4, 2001

(51) Int. Cl. B23P 19/00; B25B 27/14

(52) U.S. Cl. 29/758; 29/748; 29/750; 29/280

(57) ABSTRACT

A co-axial terminator press fitting pliers, wherein, an insertion opening defined by both inner sides of the linkage plate of the press fit pliers in relation to the other end of the cable jaw is provided to receive insertion by an insertion part defined by both sides of a press fitting block. The connection piece to receive the terminator is mounted through the press fitting block. The press fitting block is held in position on the other end of the linkage plate relatively to the cable jaw when the press fitting block is engaged in the insertion opening of the linkage plate. And the press fitting block is readily replaceable with another type of connection piece for the press fitting pliers to expand its applicability as a whole.

### BACKGROUND OF THE INVENTION

(a) Field of the Invention

The present invention relates to a pair of co-axial terminator press fitting pliers, and more particularly, to one that allows choosing a connection piece for a press fitting block in conjunction with the same press fitting pliers depending on the type of the terminator to save expenses incurred from preparing various types of press fitting pliers so to expand applicability of the press fitting pliers as a whole and improve market competition strength.

(b) Description of the Prior Art

As illustrated in FIG. 1A , FIG. 1B, FIG. 1C of the accompanying drawings, most of the terminators generally available in the market include F type (A), BNC type (B) and RCA (C) type. These types of terminators essentially differ in the connector subsequently provided to each type of terminator without significant change to the connection structure between the terminator and the co-axial signal cable. Usually the co-axial signal cable is forthwith pressed to be secured to the tail of the connector of the terminator. Accordingly, a dedicated structure of a press fitting pliers is used for the purpose and is essentially comprised of a pair of handles for the operator to hold. Both handles are pivoted at where appropriately by a pin and a working part is provided at where both handles are pressed to facilitate each element of tile working part to achieve its expected working results by pressing in the handles.

As the travel route of the pressing between the cable and the terminator relates to a straight line, the working part of the press fitting pliers is essentially having provided a cable jaw on one end of a linkage plate, and a connection piece to receive the terminator on the other end of the linkage plate. In turn, once the handles press in, the cable jaw and the connection piece respectively provided at both ends of the linkage plate, the handles travel in a route of a straight line to press against each other as driven by a mechanism inside the linkage plate to press fit the terminator to the cable wire. However, as the connector varies depending on the type of the terminator, a dedicated press fitting pliers must be prepared for each type of terminator since the interchangeability among the press fitting pliers is prevented. Therefore, to cope with various types of terminator, different types of press fitting blocks must be purchased, thus to significantly increase the costs and difficulties in field application since all types of the press fitting pliers must be carried along.

### SUMMARY OF THE INVENTION

The primary purpose of the present invention is to provide a co-axial terminator press fitting pliers that allows selection of a suitable press fitting block depending on the type of the connector of the terminator as required for the field application to adapt to the same pliers. To achieve the purpose, an insertion opening defined by both inner sides of the linkage plate of the press fit pliers in relation to the other end of the cable jaw is provided to receive insertion by an insertion part defined by both sides of a press fitting block. The connection piece to receive the terminator is mounted through the press fitting block. The press fitting block is held in position on the other end of the linkage plate relatively to the cable jaw when the press fitting block is engaged in the insertion opening of the linkage plate. And the press fitting block is readily replaceable with another type of connection piece for the press fitting pliers to expand its applicability as a whole.

Another purpose of the present invention is to provide a co-axial terminator press fitting pliers that allows control of the pressing travel. To achieve the purpose, a threaded through hole is provided in the press fitting block with its upper end to receive insertion of the rod of a knob and its lower end to fix the connection piece so to adjust the position of the connection piece in the press fitting block.

### BRIEF DESCRIPTION OF THE DRAWINGS

FIG. 1A, B, C is a view showing various types of connector provided to a co-axial terminator,

FIG. 2 is a view showing an appearance of a preferred embodiment of the present invention,

FIG. 3 is an exploded view of the preferred embodiment of the present invention,

FIG. 4 is a schematic view showing a press fitting block in motion of the preferred embodiment of the present invention,

FIG. 5 is a sectional view of the press fitting block of the preferred embodiment of the present invention, and

FIG. 6 is a schematic view showing a status of a connection piece held in position of the preferred embodiment of the present invention.

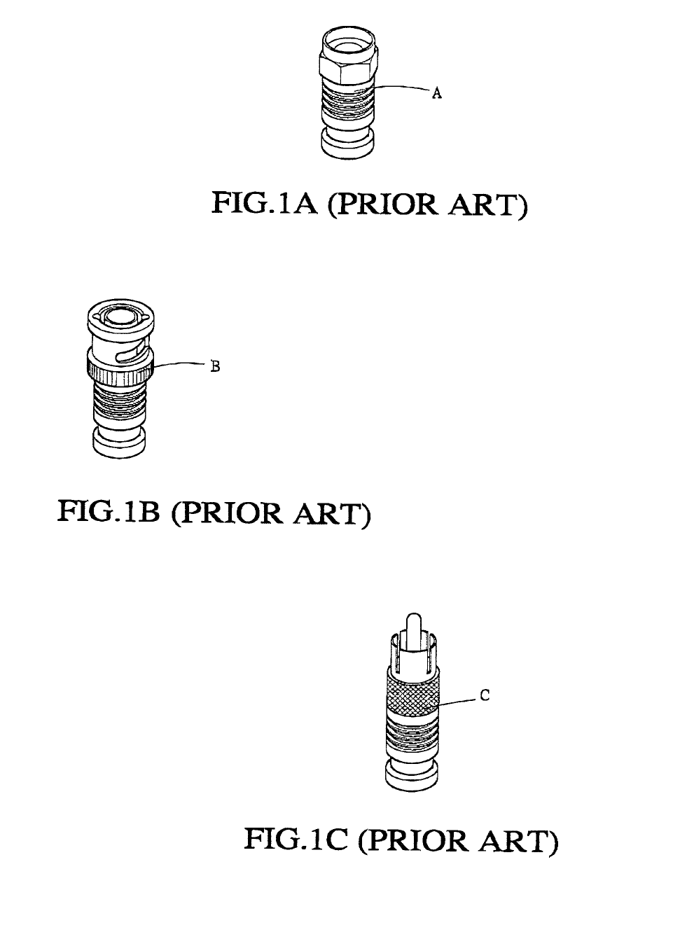

### DETAILED DESCRIPTION OF THE PREFERRED EMBODIMENTS

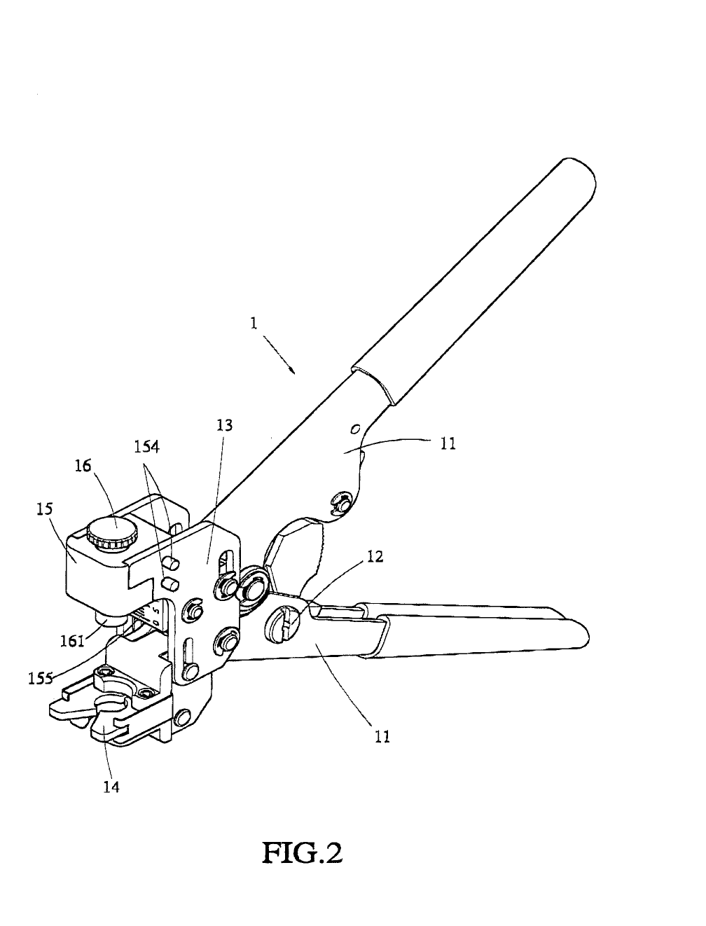

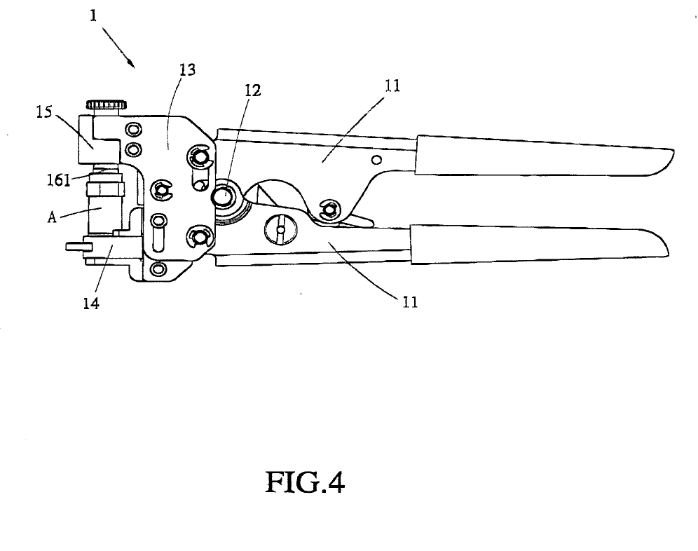

Referring to FIGS. 2 and 4 for a co-axial terminator press fitting pliers of a preferred embodiment of the present invention, wherein, the press fitting pliers (1) are provided with two handles (11) pivoted at where appropriately to each other by a bolt (12). A working part at where the handles (11) press in to facilitate each element of the working part to achieve its expected working results through the press by the handles (11). The working part of the press pliers' (1) is essentially comprised of a linkage (13) having provided at its one end a cable jaw (14), and the other end a connection piece (161) to receive insertion by the terminator. As illustrated in FIG. 4, when said both handles (11) press in, the cable jaw (14) and the connection piece (161) at both ends of the linkage plate (13) press against each other in a straight line route though the mechanical motion taking place inside the linkage plate (13) to press fit the terminator, i.e. a F-terminator (A) in this preferred embodiment.

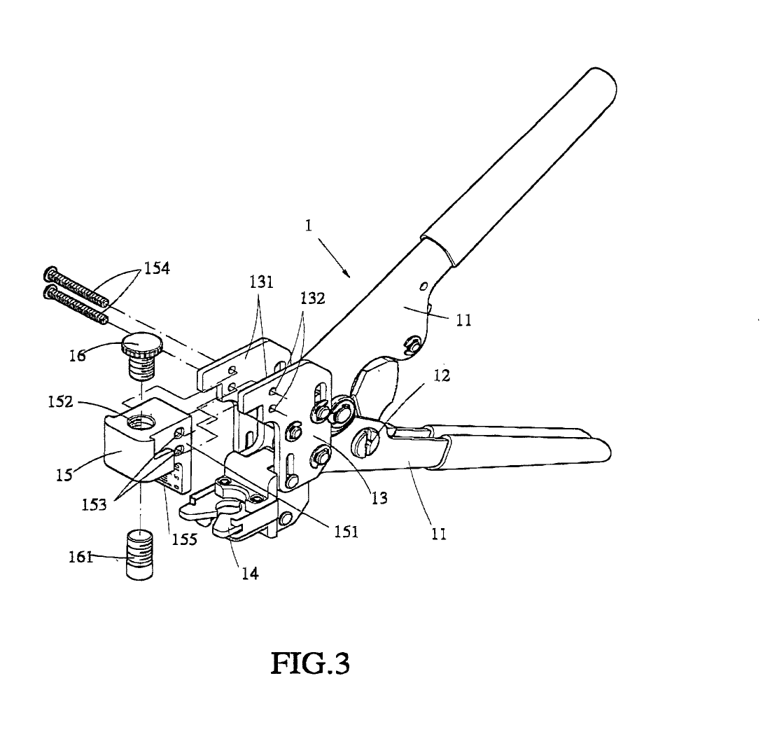

As illustrated in FIGS. 2 and 3, an insertion opening (131) defined by both inner sides of the linkage plate (13) of the press fit pliers (1) in relation to the other end of the cable jaw (14) to receive insertion by both sides (151) of a press fitting block (15). The connection piece (161) to receive the terminator is mounted through the press fitting block (15). A through hole (152) is separately formed in the press fitting block (15) to receive a knob (16) having a threaded rod, which is inserted into the through hole (152) and the connection piece (161) is fixed to the lower end of the threaded rod of the knob (16). The connection piece (161) is held in position on the other end of the linkage plate (13) relatively to the cable jaw (14) when the press fitting block (15) is engaged in the insertion opening (131) of the linkage plate (13).

At least two fastening hole (132) and corresponding locking holes (153) are respectively provided in the linkage plate (13) and the press fitting block (15) for at least two fasteners (154), e.g., bolts, each to penetrate the fastening hole (132) and the locking hole (133) for firmly secure the press fitting block (15) to the linkage plate (13). The press fitting block (15) is mounted to or removed from the linkage plate (13) simply by those fasteners (154). The press fitting block (15) can be readily replaced as required by the field application depending on the type of the connection piece (161) to expand the applicability of the press fitting pliers as a whole.

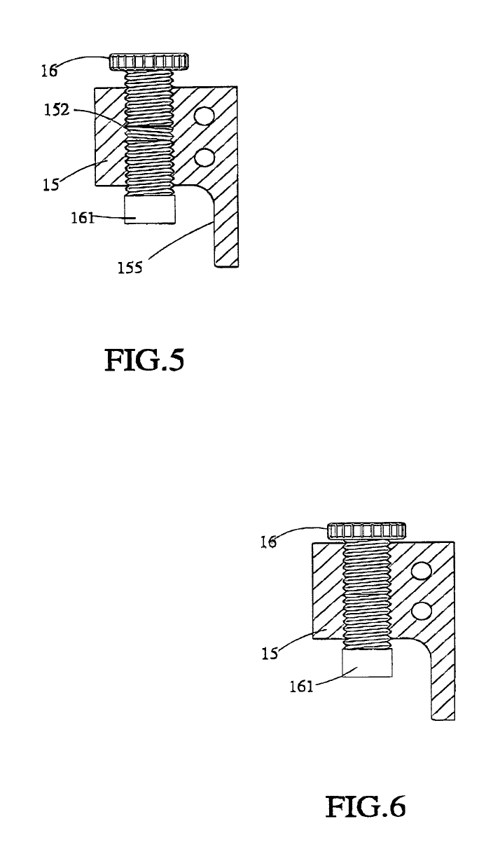

Furthermore, the connection piece (161) of the present invention to cope with various types of connector is threaded and locked in the press fitting block (15) by the knob (16). Therefore, the position of the connection piece (16) in relation to the press fitting block (15) can be readjusted by turning the knob (16) for the control of press fitting travel required. On the press fitting block (15) at where provided for the disposition of the connection piece (161) is scaled to help adjustment of the press fitting travel. As illustrated in FIGS. 5 and 6, a through hole (152) in the press fitting block (15) is threaded to respectively receive at its both ends the knob (16) and the connection piece (161). Once the connection piece (161) is adjusted to position as marked by the scale (155), the knob (16) is turned against the connection piece (161) to function as a packing element to the connection piece (161) to firmly secure it in position. Of course, the connection piece (161) can be forthwith removed from the through hole (152) for direct replacement with another type of connection piece.

The co-axial terminator press fitting pliers of the present invention provides a better application structure for press fit terminators by having the linkage plate of the press fitting pliers to define an opening in relation to the other end of the cable jaw, an insertion part to be received in the opening formed on the press fitting block, and the connection piece to engage the terminator mounted to the press fitting block for the press fitting block to be positioning on the linkage plate relatively to the other end of the cable jaw when the insertion part being engaged with the opening of the linkage plate; meanwhile, the press fitting block allowing to be adapted with a selected type of connection piece for the same press fitting pliers depending on the type of terminator to expand the applicability of the press fitting pliers as a whole. Therefore, the application for a utility patent is duly filed accordingly.

I claim,

1. A co-axial terminator press fitting pliers comprised of two handles pivoted to each other by a bolt and a working part provided at where the handles meet including a linkage provided with at one end a cable jaw, and the other end a connection piece to receive insertion by the terminator so that when said both handles press in, the cable jaw and the connection piece at both ends of the linkage plate press against each other in a straight line route though the mechanical motion taking place inside the linkage plate to press fit the terminator, characterized by that:
an insertion opening defined by both inner sides of the linkage plate of the press fit pliers in relation to the other end of the cable jaw to receive insertion by both sides of a press fitting block; the connection piece to receive the terminator being mounted through the press fitting block; the connection piece being held in position on the other end of the linkage plate relatively to the cable jaw when the press fitting block being engaged in the insertion opening of the linkage plate; and the press fitting block being readily replaceable as required by the field application depending on the type of the connection piece to expand the applicability of the press fitting pliers as a whole.

2. A co-axial terminator press fitting pliers as claimed in claim 1, wherein, a through hole is separately formed in the press fitting block to receive a knob having a threaded rod; said rod being inserted into the through hole; the connection piece being fixed to the lower end of the threaded rod of the knob; the connection piece being held in position on the other end of the linkage plate relatively to the cable jaw and the press fitting block being engaged in the insertion opening of the linkage plate.

3. A co-axial terminator press fitting pliers as claimed in claim 2, wherein, fastening hole and corresponding locking hole are respectively provided in the linkage plate and the press fitting block for a fastener, e.g., bolt, to penetrate to firmly secure the press fitting block to the linkage plate; the press fitting block being mounted to or removed from the linkage plate simply by the fastener; and the connection piece being replaceable together with the press fitting block as required in choosing a press fitting block with the suitable connection piece.

4. A co-axial terminator press fitting pliers as claimed in claim 2, wherein, on the press fitting block at where provided for the disposition of the connection piece is scaled.

5. A co-axial terminator press fitting pliers as claimed in claim 3, wherein, the fastener relates to a bolt.

6. A co-axial terminator press fitting pliers as claimed in claim 1, wherein, the press fitting block is provided with a connection piece to adapt to a co-axial terminator with an F connector.

7. A co-axial terminator press fitting pliers as claimed in claim 1, wherein, the press fitting block is provided with a connection piece to adapt to a co-axial terminator with a BNC connector.

8. A co-axial terminator press fitting pliers as claimed in claim 1, wherein, the press fitting block is provided with a connection piece to adapt to a co-axial terminator with an RCA connector.

9. A co-axial terminator press fitting pliers as claimed in claim 1, wherein, the through hole to receive the knob is threaded to respectively receive at its both ends the insertion of rods of the knob and the connection piece with the connection piece being held in position by turning the knob once the press fitting block being adjusted to its position as required.

10. A co-axial terminator press fitting pliers as claimed in claim 9, wherein, the connection piece can be forthwith removed from the through hole receiving insertion of the knob to be replaced with another type of connection piece.
